(19) United States
(12) Patent Application Publication
(10) Pub. No.: US 2008/0076091 A1
(43) Pub. Date: Mar. 27, 2008

(54) 'Turbo' prophy cup with step like prophy paste collecting reservoirs on turbine like vanes

(76) Inventor: Ronald Moreschini, Pueblo, CO (US)

Correspondence Address: RONALD MORESCHINI, 2938 HIGH AVE., PUEBLO, CO, 81008, US

(21) Appl. No.: 11/526,615

(22) Filed: Sep. 26, 2006

(51) Int. Cl. A61C 3/06

(52) U.S. Cl. 433/166

(57) ABSTRACT

This invention is a dental prophylactic polishing cup of unique design and shape having uniquely shaped turbine like ribs or vanes positioned at an angle to the long axis of the prophy cup in such a manner, that as the prophy cup is rotated, the polishing paste held in the cup and brought to bear against a tooth will be acted on by said turbine like ribs or vanes forcing the prophylactic polishing back into the cup and over a series of steps on the front inclined “working” surface of said ribs or vanes, where said steps form a series of nearly horizontal “shelves” causing the polishing paste to collect, accumulate and become entrapped, the nearly horizontal shelves, acting as/or becoming reservoirs, holding the prophylactic polishing paste inside the prophy cup, for a longer period of time.

This invention relates generally to devices used in the dental profession and more Specifically to devices used in dental prophylaxis.

As part of a dental prophylaxis the teeth are polished by a prophylactic polishing paste that is applied to the teeth by the use of a small rubber cup commonly called a prophy cup. The prophy cup is filled or loaded with the slightly abrasive prophylactic polishing paste and held against the surface of the tooth while being mechanically rotated, this in turn forces the prophylactic polishing paste to abrade across the surface of the teeth polishing them.

A common problem with the known devices of conventional type is the difficulty in retaining the prophylactic polishing paste within the prophy cup as the prophy cup is rotated against the surface of the tooth. The prophylactic prophy paste is forced out of the prophy cup by centrifugal force and the force of being displaced by the tooth. These and other forces tend to displace and throw the prophylactic polishing paste out of the prophy cup making a mess and making it necessary to refill the prophy cup many times during a dental prophylactic procedure.

This invention, an improvement on my old invention, “Turbo” prophy cup, U.S. Pat. No. 4,929,180, that was an uniquely designed prophy cup having internal ribs or vanes, such as found in some turbines, set at an angle to the long axis of the prophy cup in such a way and design that as the prophy cup is rotated, (in a counter clock wise direction when viewed from the opening of the prophy cup), the ribs or vanes will pull the prophylactic polishing paste they come in contact with into the cup, thereby counter acting the forces that tend to displace and force the polishing paste out of the cup. The present invention is an improvement on the uniquely designed internal ribs or vanes, which use the forward portion of said ribs or vanes as a “working” surface. In the old invention, this “working” surface consisted of a smooth continuous unbroken angled surface from the bottom opening of the prophy cup up to the top of the internal surface of the prophy cup. The present invention uses the same forward, or “working” portion of the ribs or vanes, and has the same smooth angled surface, but now, it is no longer continuous and unbroken, it now has numerous interruptions in the form of steps, forming and/or creating numerous nearly horizontal shelves, that collect, accumulate and entrap the prophylactic polishing paste, and now performs two services at once, one, pulling in the polishing paste with the angled ribs or vanes, and two, collecting, accumulating and entrapping the polishing paste on the nearly horizontal shelves that are acting as reservoirs. To further describe the present invention, the angled “working” surface of the ribs or vanes start upward from the bottom edge of the prophy cup for a short distance, stop, and bend backwards at a ninety degree angle, away from the direction the prophy cup is being rotated, traveling a short distance then stops, forming or creating a nearly horizontal shelf, turns upward again at the same angle it started with, for a longer distance, then repeats the same maneuvers it just finished, creating a series of steps, or nearly horizontal shelves, that will collect, accumulate and entrap prophylactic polishing paste acting as reservoirs, making it more difficult for the prophylactic polishing paste to be displaced by all the forces acting to fling it out of the prophy cup as it is being rotated. Refilling the prophy cup with the prophy paste, is also faster and easier due to the action of the turbine like ribs or vanes pulling in the prophylactic polishing paste into the prophy cup as it is rotated and pushed into the prophylactic polishing paste.

An object of the present invention is to provide a prophy cup that will save the operator time, effort and materials when performing a dental prophylactic procedure.

Another object of the present invention is to provide a prophy cup that will waste less and thereby use less prophylactic polishing paste during a dental prophylaxis, saving materials.

Another object of the present invention is to provide a prophy cup that will retain the polishing paste within the prophy cup for a longer period of time and for a greater number of revolutions of the prophy cup thereby reducing the number of times the operator must stop polishing the teeth and refill the prophy cup, thus saving time.

Another object of the present invention is to provide a prophy cup that will be easily filled or loaded with prophylactic polishing paste, thus saving effort.

Another object of the present invention is to provide a prophy cup having internal ribs or vanes designed and set at an angle to the long axis of the prophy cup in such a way that as the prophy cup is rotated the ribs or vanes act upon any thing they come in contact with in such a way that it is drawn into the cup counter acting the forces that tend to force it out of the prophy cup.

Another object of the present invention is to provide a prophy cup having internal ribs or vanes designed and set at an angle to the long axis of the prophy cup and having a plurality of steps on the forward “working” surface of the ribs or vanes creating nearly horizontal shelves that will catch, accumulate and entrap the prophylactic polishing paste resulting in a more efficient prophy cup that holds the prophylactic polishing paste longer, resulting in a dental prophylaxis done better, quicker, with less splatter, less refilling, less material and an all around better job done, with a happier patient and a happier dentist.

Another object of the present invention is to provide a prophy cup having internal ribs or vanes set at an angle to the long axis of the prophy cup where the rib or vanes would have a cross section of such a design that the leading face, or “working” surface, would be perpendicular to the center line of the prophy cup with the back side falling off at an angle giving a buttress like cross section to the rib or vane.

These and other objects and advantages of this invention will become apparent upon reading the following descriptions of which the attached drawings form a part.

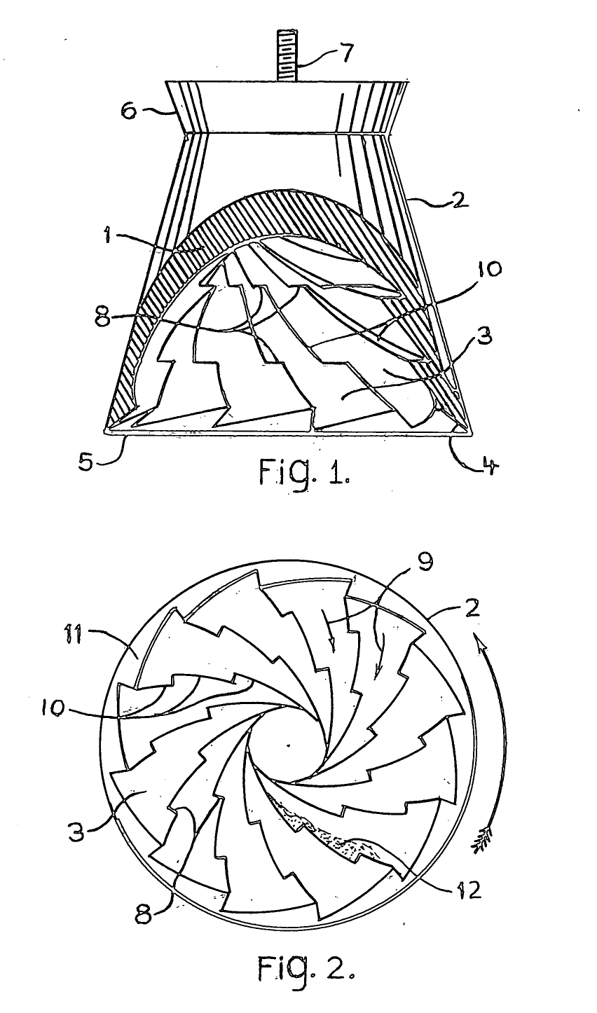

FIG. 1. Is a side view of the present invention with a section removed.

FIG. 2. Is the cup opening bottom end view of the present invention with a curved arrow showing the direction of rotation.

Referring to the drawings:

In FIG. 1, we see a side view of the present invention with a cross section 1, removed from the prophy cup 2, disclosing the ribs or vanes 3, positioned at an angle to the long axis of the prophy cup 2. FIG. 1, also shows how the angled ribs or vanes, 3 are tapered 4, at the prophy cup opening, ending in a thin edge 5, thus allowing the edge of the prophy cup to fit in and under the free margin of the gingiva surrounding the cervical portion of the human tooth, to clean and massage the same. Also seen in FIG. 1, is the skirt like projection 6, at the screw shank 7, end of the prophy cup 2, this projection with the aid of centrifugal force flings off the excess polishing paste keeping it out of the bearings and gears of the prophy angle, We also see in FIG. 1, the step like bends 8, found on the forward “working” surface 10, of the angled ribs or vanes 3. It is these plurality of steps 8, that form, and become the nearly horizontal shelves that collect, accumulate and entrap the prophylactic polishing paste, acting as reservoirs, there by resisting all of the forces tending to dislodge, and fling the prophylactic polishing paste out of the cup.

In FIG. 2. it is seen as the prophy cup 2, rotates in the direction of the arrow the ribs or vanes 3, form a vortex, or turbine like set of vanes 3, which will act upon the prophylactic polishing paste in the prophy cup 2, in such a way as to draw the prophylactic polishing paste inwards and downward into the center of the prophy cup 2, as illustrated by the small curved arrows 9. Also shown is the forward face or “working” surface 10, of the angled rib or vane 3, that is perpendicular to the centerline of the prophy cup 2, with the back side, falling off at an angle giving a buttress like cross section 11, to the rib or vane 3. The perpendicular “working” surface 10, of the rib or vane 3, would thusly exert a stronger force on the prophylactic polishing paste while the buttress like trailing portion would best support the “working” surface 10. In FIG. 2, we also see the steps 8, on the ribs or vanes 3, that become the nearly horizontal “shelves” that will catch, accumulate and entrap the prophylactic polishing paste 12, acting like reservoirs, there by counter acting the forces that are trying to dislodge and fling the prophylactic polishing paste out of the prophy cup.

This invention may be further developed within the scope of the following attached claims, accordingly, it is desired that the fore going description be read merely as being illustrative of an operative embodiment of this invention and not a strictly limiting sense.

What is claimed is:

1. A prophy cup for use with a prophy angle and dental prophylactic polishing paste comprising: a conically shaped body member, attachment means at the smaller end of said body member, the larger end of said body member having a central opening cavity for holding said prophylactic polishing paste, and a plurality of internal turbine like ribs or vanes, around the inside wall of said cavity, each rib or vane being set at a slight angle towards the direction of intended cup rotation and to have on the forward face or “working” surface of said ribs or vanes a plurality of steps forming a plurality of nearly horizontal shelves to collect, accumulate and entrap said prophylactic polishing paste, acting as and/or becoming reservoirs to hold said prophylactic polishing paste within the cup cavity during rotation and use thereof.

2. A device as set forth in claim 1, wherein said prophy cup has varieties as to number and size of said ribs or vanes on the inside of the cup.

3. A device as set forth in claim 2, wherein said prophy cup makes it faster, easier and less messy to refill the prophy cup with the prophy paste.
